(19) United States
(12) Patent Application Publication
(10) Pub. No.: US 2019/0193766 A1
(43) Pub. Date: Jun. 27, 2019

(54) REINITIALIZATION METHOD OF A ZONE CONTROLLER AND ASSOCIATED AUTOMATIC TRAIN CONTROL SYSTEM

(71) Applicant: ALSTOM Transport Technologies, Saint-Ouen (FR)

(72) Inventors: Javier BALLESTEROS, Paris (FR); Mathieu BRESSON, Paris (FR)

(21) Appl. No.: 16/229,527

(22) Filed: Dec. 21, 2018

(30) Foreign Application Priority Data
Dec. 22, 2017 (FR) 17 62959

(51) Int. Cl. B61L 27/00; G06F 9/4401

(52) U.S. Cl. CPC B61L 27/0088; B61L 2027/005; G06F 9/4401; B61L 27/0038

(57) ABSTRACT

Disclosed is a method, implemented in a supervision system for trains of the “communication-based train management” type, which includes the steps, carried out by a zone controller, including: during nominal operation, periodically saving an image of a current operational situation on an external memory; and, after a downtime period and rebooting of the zone controller: establishing an image of the operational situation after rebooting; recovering, from the external memory, the most recent saved image as image of the operational situation before failure; collecting information on the crossing of borders of the zone associated with the zone controller during the downtime period; and verifying the coherence of the image of the operational situation after rebooting from the image of the operational situation before failure and crossing information.

The present invention relates to a reinitialization method of a zone controller in an automatic train control system.

Such a system is known under the name ATC for “Automatic Train Control”.

In a known manner, an ATC includes different systems cooperating with each other to allow trains to travel safely on a railway network.

Different ATCs exist. However, the present invention more specifically relates to an ATC of the “communication-based train control” (CBTC) type.

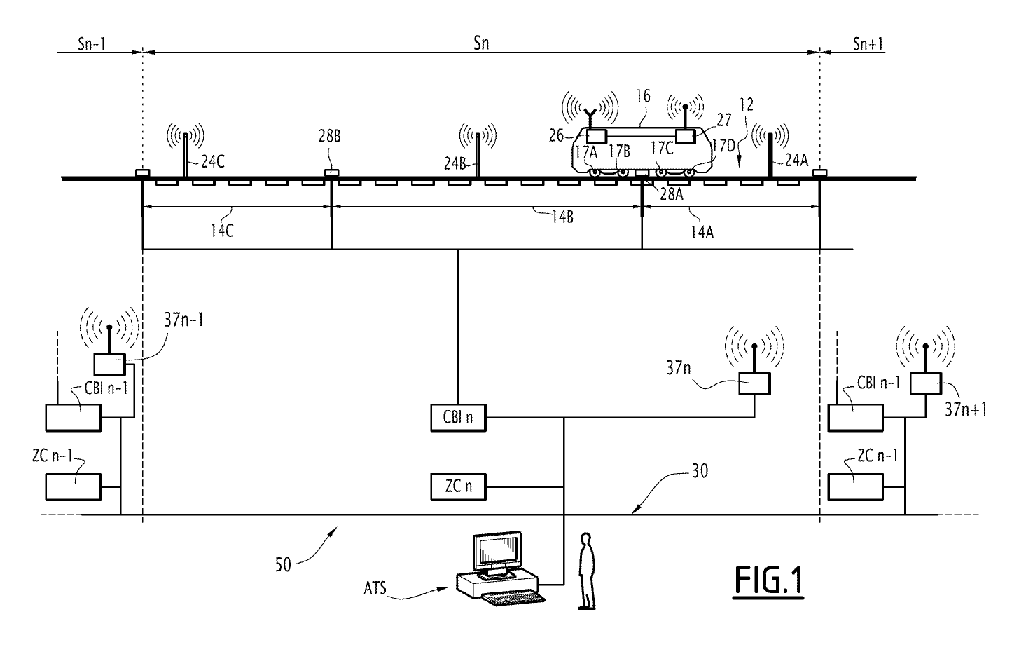

An example of a CBTC architecture is shown schematically in FIG. 1.

The CBTC architecture is based on the presence of security computers 26 on board trains 16. They make up the on-board component of the ATC.

The on-board computer of a train determines a certain number of operating parameters of the train and communicates with various systems on the ground to allow the train to perform its assigned mission safely. This on-board computer on the one hand covers the functional needs of the train, i.e., the service of predetermined stations for exchanging passengers, and on the other hand controls safety points, i.e., for instance verification that the train is not traveling at an excessive speed. The on-board computer 26 of a train 16 is connected to an onboard radiocommunication unit 27, able to establish a radio link with base stations 37 of a communication infrastructure, which in turn is connected to a communication network 30 of the CBTC architecture.

The ground component of the CBTC architecture comprises several zone controllers (ZC).

The network being subdivided into a plurality of zones, a ZC is associated with each of said zones. In FIG. 1, three successive zones are shown: Sn−1, Sn and Sn+1. A zone controller is associated with each of them: ZCn−1, ZCn and ZCn+1.

A ZC is in particular responsible on the one hand for monitoring the presence of the trains on the associated zone, and on the other hand, for providing movement authorizations to the trains that are of a nature to guarantee their safe movement, i.e., for example not to give a train a movement authorization that would cause it to go past the train preceding it.

The ATC architecture is part of an overall system, called signaling system 50 in FIG. 1, that is also able to command a plurality of pieces of equipment on the track.

The signaling system 50 includes an automatic train supervision (ATS) system. The ATS is implemented in an operational unit and comprises man/machine interfaces, allowing operators to intervene on the various systems of the signaling system and, in particular, the trackside equipment. For example, the operator can remotely control closing of the signal (turning a light red) from the ATS.

The signaling system also includes a plurality of interlocking systems. An interlocking system is for example associated with each of the zones of the network. An interlocking system is able to manage the trackside equipment, such as signal lights, switching actuators, etc., this trackside equipment allowing the trains to move safely while avoiding conflicting movements between them. Once based on electromechanical relays, today the interlocking system is computerized by suitable computers able to command the trackside equipment. Such an interlocking computer is called CBI for “Computer Based Interlocking”. In FIG. 1, an interlocking computer is associated with each of the zones: CBIn−1, CBIn and CBIn+1.

Advantageously, each zone is subdivided into a plurality of portions. In FIG. 1, three successive portions 14A, 14B and 14C are shown.

The occupancy of a portion of a zone is a key piece of information for railroad safety. The determination of that information will now be described.

A ZC receives information on the one hand from a primary detection system, and on the other hand from a secondary detection system.

The primary detection system makes it possible to determine the portion(s) occupied by a train based on the instantaneous position of the train determined by the train itself. More specifically, the ZCn receives the instantaneous position of the train 16 circulating over the zone Sn. This position is determined by the on-board computer 26 of a train from the detection of beacons 24 A-C placed along the track and whose geographical positions are known, and from odometry means equipping the train and allowing the on-board computer 26 to determine the distance traveled by the train 16 since the last beacon crossed. In another embodiment, the train uses other means to determine its instantaneous position: for example, an accelerometer (in place of the odometer) or a GPS (in place of the beacons).

From the instantaneous position of a train 16, the ZCn calculates a security envelope around the train. This envelope covers not only the train, but also the portion of the track corresponding to the maximum distance that the train could cover between the moment where it calculates its position and the moment where the ZCn receives this position information.

Additionally, as long as no other position information is received by the ZCn, the latter continues to extrapolate the position of the train to cover its potential movements.

The discrimination of a train is then the ability of a ZC to calculate such an envelope for a train circulating over the associated zone.

The concept of discrimination of the trains is for example disclosed in patent application FR 3,019,676.

From this security envelope and a geographical map of the network, on which each portion is identified uniquely, the ZCn places the portions having an intersection with the security envelope in a first state E1 assuming the value “occupied”. The first state E1 of the portions in which no train is located at the current moment i.e., the portions that have no intersections with a security envelope, assumes the value “free”. A first state E1 of the different portions is thus defined.

In this way, a first piece of occupancy information for each portion of the section Sn is determined by the ZCn.

The secondary detection system is able to back up the primary detection system, for example in the case where, the radiocommunication unit 27 of a train 16 no longer working, the ZCn can no longer obtain the instantaneous position of the train. Using suitable track equipment, positioned alongside the track, the secondary detection system is able to detect the presence of a train in a given portion of the considered section.

In one currently preferred embodiment, in order to detect the presence of a train in a portion, the secondary detection system counts the number of axles 17 entering and leaving a portion.

For example in FIG. 1, the secondary system includes an entry sensor 28A situated at the entrance to the portion 14B in question and an exit sensor 28B situated at the exit from the portion 14B. The entry and exit sensors are connected by cables to the CBIn.

The CBIn is able to keep a variable, called axle counter, of the portion 14B up to date.

When the train 16 passes in front of the entry sensor of the portion 14B, each time the passage of an axle 17 A-D by the entry sensor is detected, the CBIn adds one unit to the axle counter for the portion 14B.

When the train 16 passes in front of the exit sensor of the portion 14B, each time the passage of an axle 17 A-D by the exit sensor is detected, the CBIn subtracts one unit from the axle counter for the portion 14B.

Thus, according to the secondary detection system, the portion is in a second state E2 assuming the “free” value when the axle counter for this portion is equal to zero.

Otherwise, the second state of the portion assumes the “occupied” value.

The second state E2 of a portion constitutes a second piece of occupancy information, which is periodically sent by the CBIn to the ZCn.

The ZCn reconciles the first and second pieces of occupancy information for the portions of the zone Sn and, if they match, can authorize a train to move by assigning it a movement authorization. The endpoint of a movement authorization for a train corresponds to the entry border of the first portion in front of the train in question that is occupied by another train.

With such an architecture, it is understood that any failure of a ZC causes the stopping of operations, at least over the zone controlled by the failing ZC.

However, some failures affecting the proper operation of a zone controller are not serious and only require restarting the zone controller, optionally after a maintenance operation. If it for example involves a failure affecting the power supply of the ZC or its network card, once the failing component has been replaced, rebooting the security computer making up the ZC is necessary.

However, upon rebooting, the ZC must reestablish the discrimination of the various trains circulating over the zone that it controls in order to allow resumption of the secure supervision of the circulation of the trains.

However, the reestablishment of this discrimination requires heavy verifications to guarantee compliance with the required security level. Thus, agents must be sent onto the tracks for a manual reboot and to drive the trains by sight. This is to avoid any collision with another train, which, under its own momentum at the time of the failure of the ZC, may have entered a portion other than that which it occupied before the failure of the ZC.

Such a procedure upon rebooting a ZC is cumbersome. It may take several hours.

It disrupts the operation of the network, which is no longer available. It affects the image of the operator, travelers having to get off the trains and continue their journey by alternative means.

The invention therefore aims to offset this problem, in particular by proposing a method for reinitialization of a zone controller making it possible to reestablish the conditions for rebooting supervision of the circulation of the trains more quickly, and therefore the operation of traffic on the network.

To that end, the invention relates to a reinitialization method of a zone controller in a supervision system for trains of the “communication-based train management” type including the following steps, carried out by the zone controller: during nominal operating periods of the zone controller, periodically saving an image of a current operational situation on an external memory; and, after a downtime period of the zone controller and after the zone controller has been rebooted, during a reinitialization period: establishing an image of the operational situation after rebooting the zone controller; recovering, from the external memory, the most recent image of the saved operational situation as image of the operational situation before the failure of the zone controller; collecting information on the crossing of borders of the zone associated with the zone controller during the downtime period of the zone controller; and verifying the coherence of the image of the operational situation after rebooting the zone controller from the image of the operational situation before the failure of the zone controller and crossing information.

According to specific embodiments, the method includes one or more of the following features, considered alone or according to any technically possible combinations:
periodically saving an image of the current operational situation consists, using a communication between the zone controller and the trains present in the zone associated with the zone controller, of generating and storing a first list including: a general indicator, indicating whether all of the trains circulating at the current moment in the zone associated with the zone controller are identified by the latter and answering the latter; an identifier of each of the trains present in the zone associated with the zone controller at the current moment; for each of the trains present in the zone associated with the zone controller, a discrimination indicator, which is preferably a Boolean variable assuming the unit value when the train is discriminated by the zone controller at the current moment and the zero value when it is not.
establishing an image of the operational situation after rebooting the zone controller consists of establishing a second list including, for each train from among the trains that manage to reestablish a functional communication with the zone controller during the reinitialization period, an identifier of the train and a discrimination indicator advantageously assuming the unit value when the zone controller manages to discriminate the train and the zero value otherwise.
collecting crossing information consists of establishing: a third list, which includes, for each train from among the trains that leave an adjacent zone to enter the zone associated with the zone controller, an identifier of the train and a discrimination indicator advantageously assuming the unit value if the train was discriminated by an adjacent zone controller associated with the adjacent zone before entering the zone associated with the zone controller or the zero value if the train was not discriminated; and a fourth list, which includes, for each train from among the trains that enter an adjacent zone by leaving the zone associated with the zone controller, an identifier of said train and a discrimination indicator of the train, advantageously assuming the unit value if the train is discriminated by an adjacent zone controller associated with the adjacent zone now that it is in the adjacent zone, or the zero value if the train is not discriminated.
the crossing information is provided by each of the zone controllers adjacent to the zone controller.
the crossing information is collected by each of the adjacent zone controllers from a moment corresponding to the detection moment of the failure of the zone controller, optionally decreased by a predetermined duration corresponding to a failure detection time.
the verification consists of: if the first list includes a zero general indicator (Ind), indicating the presence of a non-communicating train in the zone associated with the zone controller before the downtime period of the latter, stopping the method; otherwise, if the third list indicates that a noncommunicating train has entered the zone associated with the zone controller during the downtime period, stopping the method; otherwise, verifying that the second list is equal to the first list, from which the trains from the third list have been added and the trains from the fourth list have been removed, a positive verification indicating a match between the operational situations before and after the downtime period of the zone controller, a negative verification indicating a mismatch.
in case of match between the operational situations before and after the downtime period of the zone controller detected during the verification step, the zone controller indicates, to a train supervision system, that the different trains in the zone associated with the zone controller are discriminated and that the automatic train supervision can resume; otherwise, the method is stopped.
the crossing information is, in whole or in part, provided by an interlocking system of the zone associated with the zone controller using an outside train detection security device.

The invention also relates to an automatic train control system of the “communication-based train management” type, characterized in that the signaling system includes at least one external memory and at least one zone controller implementing the preceding method, the zone controller periodically saving an image of the operational system on the external memory, the external memory being a memory not sharing a common failure mode with the zone controller.

The invention and its advantages will be better understood upon reading the following detailed description of one particular embodiment, provided solely as an illustrative and non-limiting example, this description being done in reference to the appended drawings, in which:

FIG. 1 is a schematic illustration of a signaling system including a train supervision system of the CBTC type;

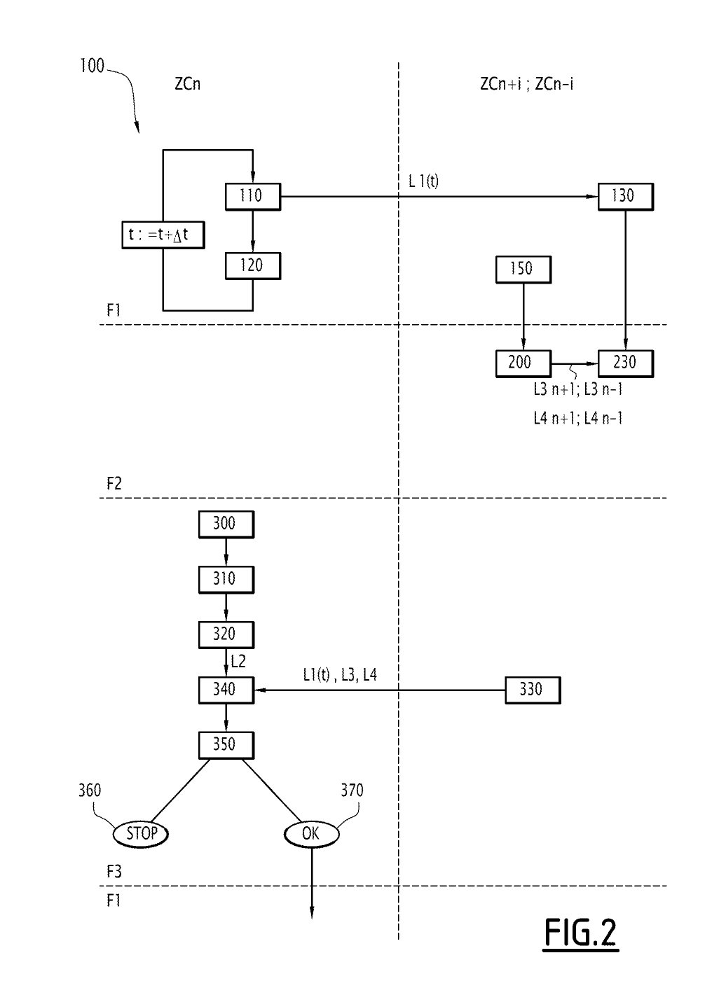

FIG. 2 is a block illustration of the method according to the invention; and

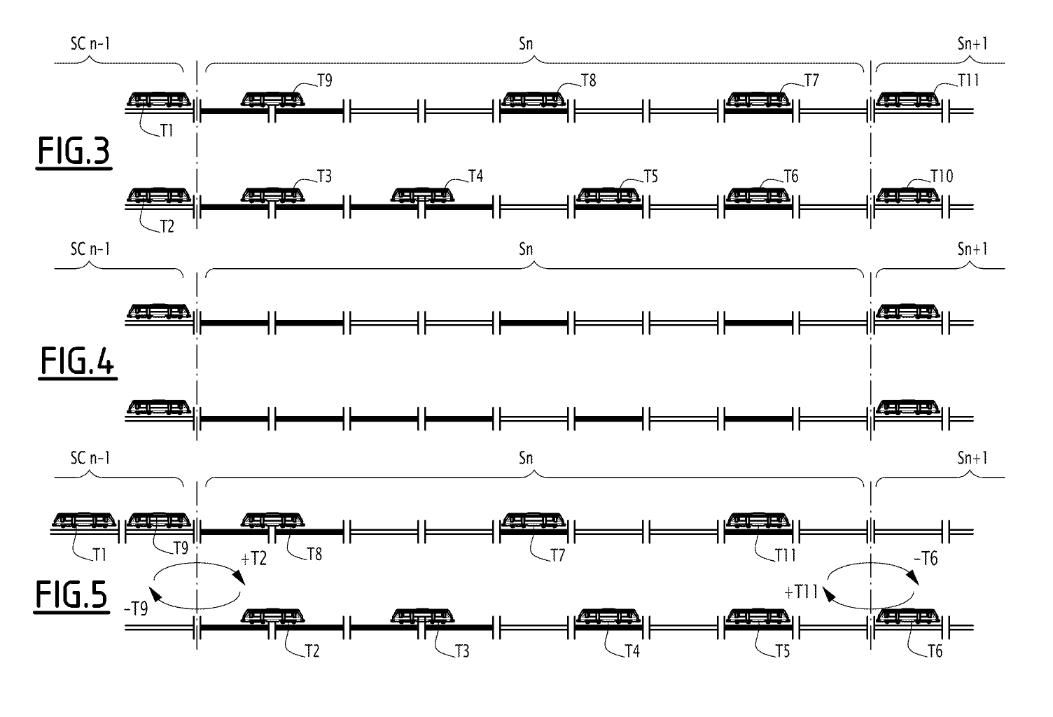

FIGS. 3, 4 and 5 are schematic illustrations of different operational situations of a section Sn controlled by a zone controller ZCn implementing the method of FIG. 2.

The general principle of the invention consists, following the reboot of the ZC, of comparing the operational situation after reboot of the ZC, reconstructing from primary and secondary information delivered by the trains and the trackside equipment, with the operational situation before the reboot of the ZC, while taking account of crossing information of the end borders of the zone associated with the failing ZC during the downtime period of the latter.

To have the operational situation before the failure, the method sets out that the current operational situation is saved periodically.

According to the method, the crossing information is determined by the zone controllers adjacent to the failing ZC, over a time period extending between several seconds before the detection of the failure of the ZC by the adjacent ZCs and the end of a reinitialization period of the ZC.

The failing ZC is then able to verify the match between the operational situation after reboot and, in the affirmative, to authorize the ATS to resume operation with complete supervision of the circulation of the trains.

In reference to FIG. 2, the preferred embodiment of the rebooting method according to the invention is shown. It is implemented by the ZCn of FIG. 1.

It is based on the establishment of four lists:
the first list L1 is made up of all of the trains circulating over the zone controlled by the ZCn before it experiences a failure;
the second list L2 is made up of the trains circulating over the zone after the reboot of the ZCn and which have reestablished a functional communication with the ZCn;
the third list L3 is made up of trains that have entered the zone Sn controlled by the ZCn during the downtime period of the latter; and
the fourth list L4 is made up of all of the trains that have left the zone Sn controlled by the ZCn during the downtime period of the latter.

During normal operation of the ZCn, period F1 in FIG. 2, the method 100 sets out the saving of the operational situation at the current moment t.

This saving consists of developing, during a step 110, the first list L1 and stamped with a save date that corresponds to the current moment t: L1 (t).

The first list L1 preferably includes the following information:
a general indicator Ind, indicating whether all of the trains circulating at the current moment t over the zone Sn controlled by the ZCn are identified by the latter and are answering the Zcn. “A train answering a ZC” means a train whose on-board computer is in functional communication with said ZC. A train not answering the ZC is a train whose on-board computer and/or on-board/ground communication means are experiencing a failure, or a train traveling on the network but which is not equipped with an on-board computer and therefore whose circulation is not supervised by the ATS.
an identifier Id_Ti of each of the trains Ti present in the zone Sn (i being an integer).
for each train Ti present in the zone Sn, a discrimination indicator Disc_Ti, which is a Boolean variable assuming the unit value when the train Ti is discriminated by the ZCn at the current moment and the zero value when it is not.

The first list L1 is next sent to a memory outside the ZCn to be saved there (step 130 in FIG. 2).

Memory outside the ZCn refers to a memory that does not share the failure modes of the ZCn. It may for example, like in the present embodiment, be the memory of an adjacent zone controller, i.e., the zone controller ZCn−1 or the zone controller ZCn+1. It may alternatively be the memory of the computers on board trains circulating in the zone controlled by the ZCn at the current moment t.

In any case, this external memory must respect the security level required by the supervision system, for example level SIL4.

Still during normal operation, the method advantageously sets out a step 120 during which the ZCn sends each train Ti the discrimination indicator Disc_Ti calculated at the current moment t.

The operational situation is saved periodically, for example with a period Δt equal to 10 seconds.

In parallel and independently, in step 150, each adjacent ZC, ZCn−1 and ZCn+1, monitors the proper operation of the ZCn. For example, a toggle is exchanged regularly between two adjacent ZCs.

When an adjacent ZC, ZCn−1 or ZCn+1, no longer receives the toggle of the ZCn, it considers that the ZCn is faulty.

During the downtime period of the ZCn, period F2 in FIG. 2, the method 100 provides, in a step 200, that each adjacent ZC, ZCn−1 and ZCn+1, develops crossing information that will make it possible to build the third and fourth lists L3 and L4.

The zone controller ZCn−1, respectively ZCn+1, develops a third upstream list L3n−1, respectively downstream list L3n+1, by storing the identifier Id_Tk of each of the trains Tk that leaves the zone Sn−1, respectively the zone Sn+1, to enter the zone Sn.

The zone controller ZCn−1, respectively ZCn+1, develops a fourth upstream list L4n−1, respectively downstream list L4n+1, by storing the identifier Id_Tk of each of the trains Tk that enters the zone Sn−1, respectively the zone Sn+1, coming from the zone Sn.

Furthermore, with each of the stored identifiers, the adjacent zone controllers ZCn and ZCn+1 associates a discrimination indicator Disc_Tk of the train Tk, assuming the unit value if the train Tk was discriminated in the zone Sn−1 or the zone Sn+1 before leaving said zone to enter the zone Sn, or is discriminated in the zone Sn−1 or the zone Sn+1 now that it has entered said zone; or the zero value if the train Tk was not or is not discriminated.

This information is stored in step 230 on the adjacent zone controllers.

The period of time over which the adjacent zone controllers store said crossing information extends from the detection moment of the failure of the ZCn, advantageously compensated by a predetermined time corresponding to a failure detection time and until the end of reinitialization moment of the ZCn.

According to the method 100, the failing ZCn is restarted in step 300, either remotely, or locally by a maintenance team intervening on its installation site. It then reenters a reinitialization period, F3 in FIG. 2.

The ZC first enters a step 310 for traditional hardware and software rebooting, then a step 320 for reinitialization of the operational situation.

During the reinitialization step 320, the ZCn builds the second list L2. This includes:
the identifiers Id_Tj of each of the trains Tj that manage to reestablish functional communication with the ZCn during the reinitialization period and to give their instantaneous position;
for each of said trains Tj, a discrimination indicator Disc_Tj assuming the unit value for a train Tj that the ZCn manages to discriminate, and the zero value otherwise.

In step 340, the ZCn queries the external memory and the adjacent zone controllers, which are one and the same in the present embodiment.

After reading their memory (step 33), the ZCn−1 and ZCn+1 send, during step 330, the ZCn the most recent saved list L1 from before the failure of the ZCn.

The ZCn−1 and ZCn+1 also send, during step 330, the ZCn the third and fourth upstream and downstream lists including the crossing information in one direction or the other for the borders delimiting the zone Sn.

The third list L3, respectively the fourth list L4, is obtained by the concatenation of the third upstream and downstream lists, respectively the fourth upstream and downstream lists, established by each of the adjacent zone controllers.

The reinitialization period is chosen to be long enough for the different trains to be able to communicate their instantaneous position to the ZCn, and for the latter to be able to discriminate them. It is also chosen to be long enough for the adjacent zone controllers to communicate crossing information to the ZCn and for the external memory to communicate the operational situation before the failure to the ZCn.

The reinitialization ends with a step 350 for verifying the coherence between the operational situations before and after the downtime period of the ZCn.

Step 350 consists of comparing the first and second lists L1 and L2 to one another, taking account of the crossing information of the third and fourth lists L3 and L4.

More specifically, if the first list L1 includes a zero general indicator Ind, indicating the presence of a noncommunicating train over the zone Sn before the failure of the ZCn, the reboot method is stopped (step 360). Indeed, it is not possible to return to an operational situation that would allow the trains to circulate safely, since it is not possible to determine the position this noncommunicating train would occupy over the zone Sn or the adjacent zones Sn+1 or Sn−1 at the time of the reboot.

Then, if the third list L3 indicates that a noncommunicating train has entered the zone Sn, the reboot method is stopped (step 360). Once again, in this case, it is not possible to reestablish an operational situation without having more information about the location of this noncommunicating train over the zone Sn.

The ZCn next considers the four lists it has and verifies that the second list L2 is equal to the first list L1 from which the trains of the third list L3 were added (trains having entered the zone Sn during the downtime period of the ZCn) and the trains from the fourth list L4 removed (trains having left the zone Sn during the downtime period of the ZCn).

In case of positive verification, indicating coherence between the operational situation after the failure and operational situation before the failure, the ZCn indicates, in step 370, to the ATS that the different trains over the Sn are discriminated and that the automatic supervision of the trains can resume. One then returns to the nominal exploitation mode of the network, corresponding to the operating mode of period F1.

In case of negative verification, the method is stopped (step 360), since the reconciliation between the lists did not make it possible to see to the coherence between the operational situations before and after the failure of the ZCn.

FIGS. 3, 4 and 5 show different situations in a zone Sn of a network including an outgoing track and a return track.

FIG. 3 shows the operational situation before the failure of the ZC controlling the zone Sn. There are seven trains, T3 to T9, managed by the ZCn, two trains, T1 and T2, managed by the ZCn−1, and two trains, T10 and T11, managed by the ZCn+1.

In this example, all of the trains managed by the ZCn are discriminated and each occupy either one portion or two portions (when the considered train is on the border between these two portions). A portion of the zone Sn occupied by a train is outlined in the figures.

The ZCn then experiences a failure.

At the time of the failure of the ZCn, the on-board computers of the trains T3 to T9, recognizing that the communication with the ZCn is lost, trigger emergency braking.

Recognizing the failure of the ZCn, the ZCn−1 modifies the movement authorization of the train T2 so that its endpoint corresponds to the border between the zones Sn−1 and Sn. When the train T2 is too close to the border, this may lead to triggering emergency braking. It is then possible that, under its own momentum, the train T2 may enter the zone Sn.

A similar description could be done for the ZCn+1 and the train T11.

The trains thus travel a certain distance before stopping completely. Their positions therefore change relative to the operational situation before the failure of the ZCn: some trains may still be present in the zone Sn, others have left the zone Sn, still others may have entered it.

The ZCn is next rebooted.

Through the primary and secondary information, the ZCn recognizes, as shown in FIG. 4, that ten portions are now occupied.

Owing to the implementation of the method 100, the ZCn is able to find the number of trains present in the zone Sn and verify that no other noncommunicating train is present in the zone Sn after rebooting. This is shown in FIG. 5.

In particular, the ZCn is informed by the adjacent ZCs of the crossings: exit of the trains T9 and T6 and entry of the trains T11 and T2.

After rebooting, the ZCn therefore manages automatically and autonomously to reestablish an accurate identification of the current operational situation.

It informs the ATS thereof for resumption of the traffic.

Many alternatives of this method can be considered.

In particular, the CBIn can be adapted to collect the crossing information during the downtime period of the ZCn and to communicate it to the ZCn upon rebooting the latter in place of the zone controllers owing to the installation of outside security equipment detecting the entry of a vehicle in the zone Sn. This alternative is particularly suitable for the case where the section Sn controlled by the failing ZCn is an end section of the supervision infrastructure, the trains not being supervised over the zone Sn+1 for example, which is not equipped with a zone controller.

It will be stressed that any train Tk that enters the section Sn associated with the zone controller from the non-equipped adjacent section Sn+1 is not discriminated. The indicator Disc_Tk is therefore in a restrictive state. This state causes the automatic reinitialization process of the zone controller to stop. Indeed, it is not possible to know whether the train Tk enters alone, pulled by another vehicle, with another vehicle behind it, or if several trains enter successively on the section Sn.

In the embodiment of FIGS. 3, 4 and 5, the subdivision of a section into portions is fixed. The supervision system only allows the circulation of a single train at most on each portion. However, the method described above also applies to the case of a dynamic subdivision of a portion, according to which several trains can be engaged at the same time on a same portion, the latter then being virtually subdivided into a plurality of sub-portions with moving borders. The border of a sub-portion is determined from the current position of the rear of a preceding train and a safety distance. The movement authorization of a following train then extends to an endpoint corresponding to the border with the first sub-portion, in the circulation direction of the following train, occupied by the preceding train.

One skilled in the art will note that this rebooting method has many advantages. It reduces the time needed to return to the nominal mode. This method is carried out automatically by the zone controller. As a result, the impact of a malfunction or a failure of a zone controller on the operation of the network is greatly minimized.

Since it involves returning to an operational situation making it possible to respect the security level required by the supervision, for example level SIL4, this method does not currently make it possible to address cases where a noncommunicating train is circulating on the zone at the time of the failure of the zone controller or enters the zone controlled by a zone controller while the latter is unavailable.

It will be noted that the general indicator Ind makes it possible to determine whether the automatic reinitialization method is allowed to finish. In order for the general indicator Ind to be permissive, it is necessary for all of the trains to be discriminated and for no communicating train to be present.

Step 120 for transmission of the parameter Disc_Ti from the zone controller to each discriminated train makes it possible for each train to determine whether it has been discriminated by the zone controller associated with the zone in which it is circulating.

If the initialization method is unsuccessful, this provides an end indicator to determine where the problem is coming from, in a retrospective analysis of the situation.

1. A reinitialization method (100) of a zone controller (ZCn) in a train supervision system of the “communication-based train control” type, including the following steps, carried out by the zone controller (ZCn):
during a nominal operating period (F1) of the zone controller, periodically saving (110, 130) an image of a current operational situation on an external memory; and
after a downtime period (F2) of the zone controller and after the zone controller has been rebooted (300), during a reinitialization period (F3):
establishing (320) an image of the operational situation after rebooting the zone controller;
recovering (340), from the external memory, a most recent image of the saved operational situation as image of the operational situation before the failure of the zone controller;
collecting (340) crossing information on the crossing of borders of a zone (Sn) associated with the zone controller (ZCn) during the downtime period of the zone controller; and
verifying (350) the coherence of the image of the operational situation after rebooting the zone controller from the image of the operational situation before the failure of the zone controller and crossing information.

2. The method (100) according to claim 1, wherein periodically saving an image of the current operational situation consists, using a communication between the zone controller and the trains present in the zone associated with the zone controller, of generating (110) and storing (130) a first list (L1) including:
a general indicator Ind, indicating whether all of the trains circulating at the current moment over the zone (Sn) associated with the zone controller are identified by the latter and are answering the latter;
an identifier of each of the trains present in the zone associated with the zone controller at the current moment;
for each of the trains present in the zone associated with the zone controller, a discrimination indicator.

3. The method (100) according to claim 2, wherein establishing an image of the operational situation after rebooting the zone controller (ZCn) consists of establishing a second list (L2) including, for each train from among the trains that manage to reestablish a functional communication with the zone controller during the reinitialization period, an identifier of the train and a discrimination indicator advantageously assuming the unit value when the zone controller (ZCn) manages to discriminate the train and the zero value otherwise.

4. The method (100) according to claim 3, wherein collecting crossing information consists of establishing:
a third list (L3), which includes, for each train from among the trains that leave an adjacent zone (Sn−1, Sn+1) to enter the zone (Sn) associated with the zone controller (ZCn), an identifier of the train and a discrimination indicator advantageously assuming the unit value if the train was discriminated by an adjacent zone controller (ZCn−1, ZCn+1) associated with the adjacent zone (Sn−1, Sn+1) before entering the zone (Sn) associated with the zone controller (ZCn) or the zero value if the train was not discriminated; and
a fourth list (L4), which includes, for each train from among the trains that enter an adjacent zone (Sn−1, Sn+1) by leaving the zone (Sn) associated with the zone controller (ZCn), an identifier of said train and a discrimination indicator of the train, advantageously assuming the unit value if the train is discriminated by an adjacent zone controller (ZCn−1, ZCn+1) associated with the adjacent zone (Sn−1, Sn+1) now that it is in the adjacent zone, or the zero value if the train is not discriminated.

5. The method (100) according to claim 4, wherein the crossing information is provided by each of the zone controllers (ZCn−1, ZCn+1) adjacent to the zone controller (ZCn).

6. The method (100) according to claim 5, wherein the crossing information is collected by each of the adjacent zone controllers from a moment corresponding to a detection moment of a failure of the zone controller.

7. The method (100) according to claim 4, wherein the verification step (350) consists of:
if the first list (L1) includes a zero general indicator (Ind), indicating the presence of a noncommunicating train in the zone (Sn) associated with the zone controller (ZCn) before the downtime period of the latter, stopping the method;
otherwise, if the third list (L3) indicates that a noncommunicating train has entered the zone (Sn) associated with the zone controller (ZCn) during the downtime period, stopping the method;
otherwise, verifying that the second list (L2) is equal to the first list (L1), from which the trains from the third list (L3) have been added and the trains from the fourth list (L4) have been removed, a positive verification indicating a match between the operational situations before and after the downtime period of the zone controller, a negative verification indicating a mismatch.

8. The method (100) according to claim 1, wherein, in case of match between the operational situations before and after the downtime period of the zone controller detected during the verification step, the zone controller (ZCn) indicates (370), to a train supervision system (ATS), that the different trains in the zone (Sn) associated with the zone controller (ZCn) are discriminated and that the automatic train supervision can resume; otherwise, the method is stopped.

9. The method according to claim 4, wherein the crossing information is, in whole or in part, provided by an interlocking system (CBIn) of the zone (Sn) associated with the zone controller (ZCn) using an outside train detection security device.

10. An automatic train control system of the “communication-based train control” type, wherein the signaling system includes at least one external memory and at least one zone controller (ZCn) implementing the method according to claim 1, the zone controller (ZCn) periodically saving an image of the operational system on the external memory, the external memory being a memory not sharing a common failure mode with the zone controller.

11. The method of claim 2, wherein the discrimination indicator is a Boolean variable assuming the unit value when the train is discriminated by the zone controller at the current moment and the zero value when the train is not

12. The method (100) according to claim 1, wherein establishing an image of the operational situation after rebooting the zone controller (ZCn) consists of establishing a second list (L2) including, for each train from among the trains that manage to reestablish a functional communication with the zone controller during the reinitialization period, an identifier of the train and a discrimination indicator advantageously assuming the unit value when the zone controller (ZCn) manages to discriminate the train and the zero value otherwise.

13. The method (100) according to claim 1, wherein collecting crossing information consists of establishing:
a third list (L3), which includes, for each train from among the trains that leave an adjacent zone (Sn−1, Sn+1) to enter the zone (Sn) associated with the zone controller (ZCn), an identifier of the train and a discrimination indicator advantageously assuming the unit value if the train was discriminated by an adjacent zone controller (ZCn−1, ZCn+1) associated with the adjacent zone (Sn−1, Sn+1) before entering the zone (Sn) associated with the zone controller (ZCn) or the zero value if the train was not discriminated; and
a fourth list (L4), which includes, for each train from among the trains that enter an adjacent zone (Sn−1, Sn+1) by leaving the zone (Sn) associated with the zone controller (ZCn), an identifier of said train and a discrimination indicator of the train, advantageously assuming the unit value if the train is discriminated by an adjacent zone controller (ZCn−1, ZCn+1) associated with the adjacent zone (Sn−1, Sn+1) now that it is in the adjacent zone, or the zero value if the train is not discriminated.

14. The method (100) according to claim 2, wherein collecting crossing information consists of establishing:
a third list (L3), which includes, for each train from among the trains that leave an adjacent zone (Sn−1, Sn+1) to enter the zone (Sn) associated with the zone controller (ZCn), an identifier of the train and a discrimination indicator advantageously assuming the unit value if the train was discriminated by an adjacent zone controller (ZCn−1, ZCn+1) associated with the adjacent zone (Sn−1, Sn+1) before entering the zone (Sn) associated with the zone controller (ZCn) or the zero value if the train was not discriminated; and
a fourth list (L4), which includes, for each train from among the trains that enter an adjacent zone (Sn−1, Sn+1) by leaving the zone (Sn) associated with the zone controller (ZCn), an identifier of said train and a discrimination indicator of the train,
advantageously assuming the unit value if the train is discriminated by an adjacent zone controller (ZCn−1, ZCn+1) associated with the adjacent zone (Sn−1, Sn+1) now that it is in the adjacent zone, or the zero value if the train is not discriminated.

15. The method (100) according to claim 5, wherein the crossing information is collected by each of the adjacent zone controllers from a moment corresponding to a detection moment of a failure of the zone controller, decreased by a predetermined duration corresponding to the failure detection time.

16. The method (100) according to claim 2, wherein, in case of match between the operational situations before and after the downtime period of the zone controller detected during the verification step, the zone controller (ZCn) indicates (370), to a train supervision system (ATS), that the different trains in the zone (Sn) associated with the zone controller (ZCn) are discriminated and that the automatic train supervision can resume; otherwise, the method is stopped.

17. The method (100) according to claim 3, wherein, in case of match between the operational situations before and after the downtime period of the zone controller detected during the verification step, the zone controller (ZCn) indicates (370), to a train supervision system (ATS), that the different trains in the zone (Sn) associated with the zone controller (ZCn) are discriminated and that the automatic train supervision can resume; otherwise, the method is stopped.

18. The method (100) according to claim 4, wherein, in case of match between the operational situations before and after the downtime period of the zone controller detected during the verification step, the zone controller (ZCn) indicates (370), to a train supervision system (ATS), that the different trains in the zone (Sn) associated with the zone controller (ZCn) are discriminated and that the automatic train supervision can resume; otherwise, the method is stopped.

19. The method (100) according to claim 5, wherein, in case of match between the operational situations before and after the downtime period of the zone controller detected during the verification step, the zone controller (ZCn) indicates (370), to a train supervision system (ATS), that the different trains in the zone (Sn) associated with the zone controller (ZCn) are discriminated and that the automatic train supervision can resume; otherwise, the method is stopped.

20. The method (100) according to claim 6, wherein, in case of match between the operational situations before and after the downtime period of the zone controller detected during the verification step, the zone controller (ZCn) indicates (370), to a train supervision system (ATS), that the different trains in the zone (Sn) associated with the zone controller (ZCn) are discriminated and that the automatic train supervision can resume; otherwise, the method is stopped.
